(19) United States
(12) Patent Application Publication
(10) Pub. No.: US 2009/0320406 A1
(43) Pub. Date: Dec. 31, 2009

(54) APPLICATOR TOOL

(75) Inventors: John J. Dyer, Shoreview, MN (US); Christopher A. Haak, Oakdale, MN (US); Ryan B. Prince, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/163,076

(22) Filed: Jun. 27, 2008

(51) Int. Cl. E04B 1/00; B29C 65/00; B31B 1/60

(52) U.S. Cl. 52/746.1; 156/574; 156/60

(57) ABSTRACT

A tool for applying an elongate adhesive attachment article to a window assembly including a window film and window frame includes a body having a contact surface for guiding the tool along the substrate, a positioner arranged to align the adhesive article on the window assembly, and a force applier configured to apply a force to the attachment article in the direction of the window assembly. A method of securing a window film to a window frame using such a tool is also provided.

### BACKGROUND

The present invention relates generally to tools and, more particularly, to a hand tool for applying an adhesive attachment article to a window film affixed to a window and to a window frame.

Window films are commonly applied to ordinary window glass, such as, for example, existing windows in commercial buildings or residences, to enhance the impact resistance and other properties of the window. Such window films are available from 3M Company, St. Paul, Minn., under the trade designation 3M SCOTCHSHIELD Ultra Safety and Security window film. Such window films provide protection against, for example, storm damage, earthquakes, explosions, and “smash-and-grab” burglaries.

Such window films are adhesively bonded to the window glass, and the edge of the window film is secured to the window frame using, for example, an adhesive mounting article, such as those described in U.S. Pat. No. 5,992,107 (Poirier), U.S. Pat. No. 6,931,799 (Webb), and U.S. application Ser. No. 11/959,072. Such mounting articles are applied by hand (i.e. without the aid of a tool) along the edge of the window film and along the adjacent edge portion of the window frame such that, in the event of an impact to the window glass, the window film holds the shattered glass in place, and the mounting article serves to hold the window film and the adhered shattered glass to the window frame. By retaining the shattered glass in the window opening, the window film reduces the potential for flying glass to cause injuries to occupants of the building, and also prevents wind and rain from entering and damaging the interior of the structure.

### SUMMARY

Applying an adhesive attachment article to a window film and window frame is difficult and time consuming, and misapplication of such articles can result in costly and time consuming rework. Proper application of adhesive attachment articles is desirable to produce a finished window having a pleasing appearance, and to ensure that the article performs as intended. The need therefore exists for a way to quickly, easily, and accurately apply adhesive mounting articles to a window film and a window frame.

The present invention provides a tool for quickly, easily, and accurately applying an elongate adhesive attachment article to a substrate. The tool generally includes a body having a manually grasping portion, such as a handle, a contact surface for guiding the tool along the substrate, a positioner configured to align the attachment article on the substrate, and an optional force applier configured to apply a force to the attachment article in the direction of the substrate.

In one aspect, the present invention provides a tool for applying an elongated adhesive attachment article to a window film arranged on a window and a window frame, wherein the tool includes a body having at least one end portion, and first and second angled side portions extending from the end portion, wherein the angled side portions include a pair of proximal edges defining an application path, a handle connected with the body opposite the application path, and an optional force applier arranged along the application path for applying a force to the attachment article, thereby to secure the attachment article to the window film and window frame.

In various other aspects, the body may include a pair of guide portions each having a contact surface; the substrate may include a pair of surfaces arranged at an angle, and the guide portions may each include generally planar contact surfaces arranged at an angle configured to match the angle between the substrate surfaces; the contact surfaces may be arranged at an angle of about 90 degrees; the contact surfaces may include a non-scratch coating; the contact surfaces may include first and second ends that define a first top pair of spaced parallel edges adjacent the handle and a second bottom pair of spaced parallel edges opposite the first top pair of parallel edges, and the distance between the first pair of spaced parallel edges may be greater than the distance between the second pair of spaced parallel edges; the second pair of spaced parallel edges may define a slot; the tool may comprise first and second end portions; the optional force applier may be arranged adjacent at least one of the contact surface first and second ends; the optional force applier may be movably connected with at least one of the first and second end portions; the optional force applier may be arranged in the slot between the first and second end portions; the optional force applier may be a disc-like member rotatably connected with the body; the positioner may be arranged adjacent at least one of the contact surface first and second ends; the positioner may be a unitary portion of at least one of the first and second end portions of the body of the tool; and the positioner may be formed as a unitary portion of the force applier.

In another aspect, the present invention provides a method of securing a window film to a window frame comprising the steps of: providing an elongate adhesive attachment article; providing a tool for applying the attachment article to the window film and the window frame, wherein the tool comprises a handle portion, a body portion connected with the handle portion, the body portion including an end portion and first and second angled side portions extending from the end portion, wherein the angled side portions include edges opposite the handle portion defining an application path, a positioner arranged along the application path to locate the attachment article at the desired location along the window film and window frame, and a force applier arranged along the application path to apply a force to the attachment article; positioning the tool with the first and second angled side portions abutting the window film and window frame; and moving the tool along the window film and window frame with the attachment article positioned in the application path, whereby the positioner locates the attachment article at the desired location along the window film and window frame, and the force applier forces the attachment article against the window film and window frame, thereby adhesively bonding at least a portion of the attachment article to the window film and the window frame.

In another aspect, the attachment article may be applied to the substrate by first moving the tool along the window film and window frame to position the attachment article at the desired location along the window film and window frame in a first pass of the tool, and then contacting the positioned attachment article with the force application member and moving the tool along the attachment article to press the attachment article against the window film and window frame in a second pass of the tool.

In other aspects, the step of positioning the attachment article along the window film and window frame, and the step of pressing the attachment article against the window film and window frame may be performed using a singe tool or performed using two separate tools.

### BRIEF DESCRIPTION OF THE DRAWINGS

The present invention will be further described with reference to the accompanying drawings, in which:

FIG. 1 is a perspective view of an applicator tool according to the invention;

FIG. 2A is an enlarged perspective view of an attachment article;

FIG. 2B is a cross sectional view of an impact resistant window assembly including the attachment article of FIG. 2A being used to secure a window film to a window frame;

FIG. 3 is a perspective view of an applicator tool according to a second embodiment of the invention;

FIG. 4 is a perspective view of an applicator tool according to a third embodiment of the invention;

FIG. 5 is a perspective view showing the applicator tool of FIG. 4 being used to apply an attachment article to a window assembly; and

FIG. 6 is a perspective view of an applicator tool according to a fourth embodiment of the invention.

### DETAILED DESCRIPTION

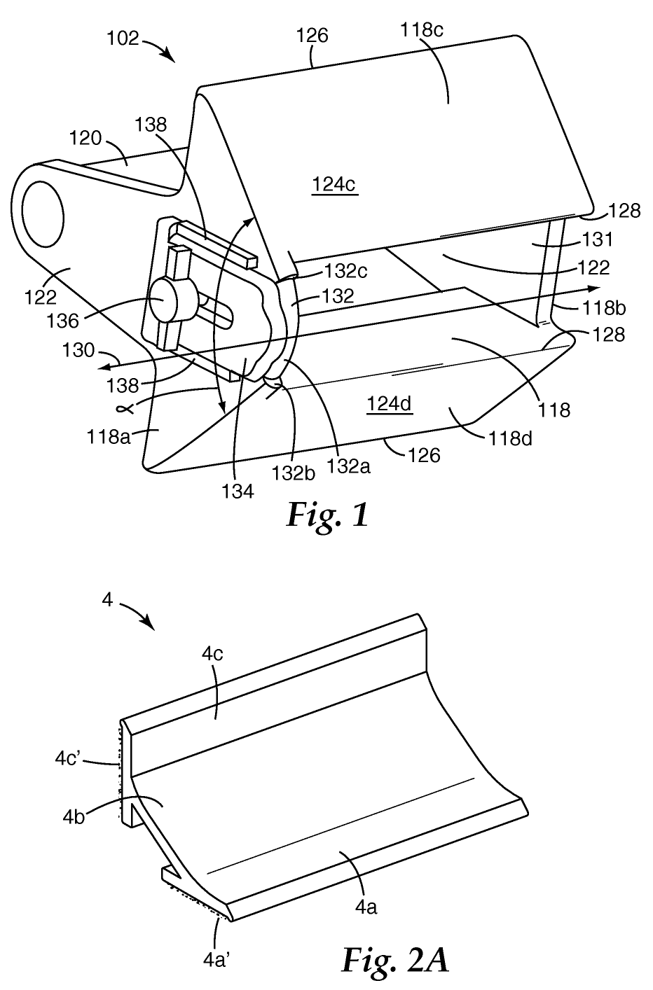

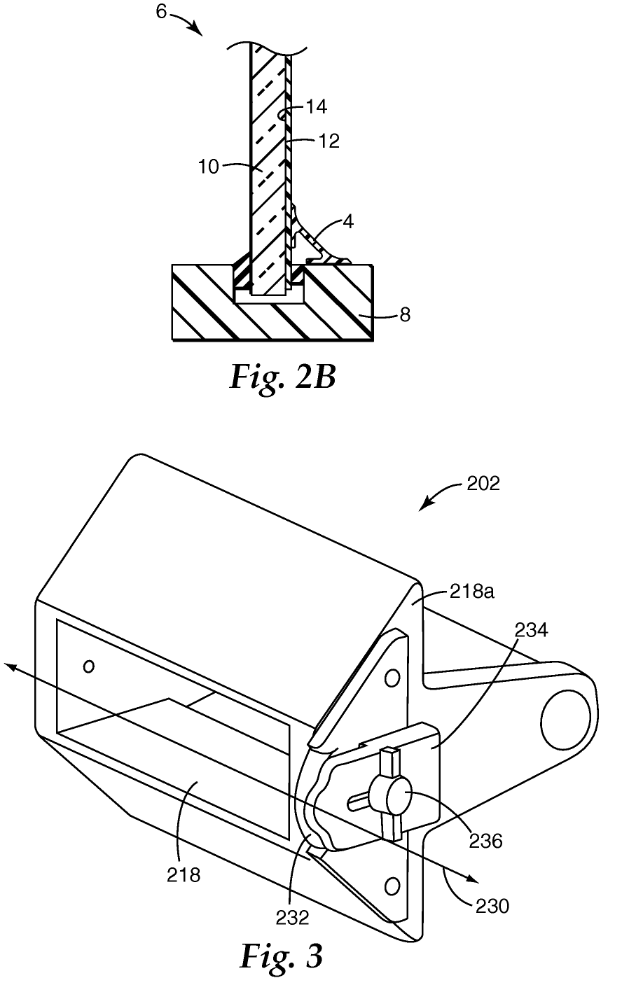

Referring now to the drawings, wherein like reference numerals refer to like or corresponding parts throughout the several views, FIG. 1 shows a manually-operated applicator tool 102 for applying an elongate adhesive attachment article to a window assembly. FIGS. 2A and 2B show an exemplary elongate adhesive attachment article 4, and an exemplary window assembly 6 using the attachment article 4.

As shown in FIG. 2A, the attachment article 4 generally includes an elongate body having a first portion 4a, a connecting portion 4b, and a second portion 4c. The first and second portions 4a, 4c include adhesive surfaces 4a′, 4c′, respectively, which, during use, are adhesively bonded to the respective surfaces of a window film and a window frame. The adhesive surfaces 4a′, 4c′ may be provided, for example, with a double-sided adhesive tape such as 3M VHB acrylic foam tape available from 3M Company, St. Paul, Minn. To protect the adhesive surfaces prior to use, the adhesive surfaces 4a′, 4c′ may be covered with a suitable release liner (not shown), as is well known in the art.

In the illustrated embodiment, the attachment article 4 has a symmetric and uniform cross-section, and has a unitary (i.e. single piece), construction. Attachment articles having other cross-sections and constructions may also be used. In the illustrated embodiment, the attachment article 4 is flexible, and may be formed of an elastomeric material such as ethylene propylene diene monomer (EPDM) rubber. Additional details of a suitable adhesive attachment article 4 are provided in U.S. patent application Ser. No. 11/959,072 (filed Dec. 18, 2007), the entire contents of which are hereby incorporated by reference.

Referring to FIG. 2B, the window assembly 6 generally includes a window frame 8, a pane of window glass or glazing 10 arranged within the window frame 8, and window film 12 applied to the interior surface 14 of the glazing 10. The attachment article 4 is applied to the perimeter of the window film 12, and to adjacent edges of the window frame 8, thereby securing the window film 12 to the window frame 8.

Referring again to FIG. 1, the applicator tool 102 includes an applicator body 118, a handle 120, supports 122 on each side of the handle 120 that connect the handle 120 with the applicator body 118, a positioner 132, and an optional force applier 134. The applicator body 118 includes first and second spaced end wall portions 118a, 118b, and first and second angled side wall guide portions 118c, 118d that extend from the first end wall portion 118a to the second end wall portion 118b.

The angled side wall guide portions 118c, 118d include contact surfaces 124c, 124d, respectively, for guiding the tool 102 along a substrate surface, such as the surface of a window film 12 applied to a pane of window glass 10, or the surface of a window frame 8, or along two such substrate surfaces simultaneously.

The contact surfaces 124c, 124d are arranged such that they taper inwardly in the direction away from the handle 120, thereby defining a pair of widely spaced edges 126 proximate the handle 120, and a pair of closely spaced edges 128 opposite the widely spaced edges 126. That is, contact surfaces 124c, 124d include a first or “top” pair of spaced parallel edges 126 adjacent the handle 120, and a second or “bottom” pair of spaced parallel edges 128 opposite the first top pair of parallel edges 126, and the distance between the first top pair of spaced parallel edges 126 is greater than the distance between the second pair of spaced parallel edges 128. The closely spaced edges 128 define an application path 130 that extends generally between the closely spaced edges 128 in the direction from the first end wall portion 118a to the second end wall portion 118b. When the tool 102 is being used to apply an attachment article 4 to a surface, the attachment article 4 will be arranged generally in and along the application path 130.

The contact surfaces 124c, 124d are arranged at an angle designed to allow the contact surfaces 124c, 124d to simultaneously engage the adjacent surfaces of a window frame 8 and an associated window 10 having a window film 12 applied thereto as illustrated in FIG. 2B. That is, the contact surfaces 124c, 124d are arranged at an angle that closely matches the corner angle formed by the window 10 and window frame 8 of the window assembly 6. Arranged in this manner, when the tool 102 is placed in the corner, the contact surfaces 124c, 124d serve to guide the tool 102 into the corner, and thereby properly position the applicator tool 102 along the window frame 8 and the window 10 so that the attachment article 4 can be aligned in equally overlapping relation with the window frame 8 and window 10.

In the illustrated embodiment, the contact surfaces 124c, 124d are generally planar surfaces, and are arranged at an angle α of about 90°, which is a typical corner angle for many window assemblies. Other angles may be used to accommodate other window assemblies. To facilitate movement of the contact surfaces 124c, 124d along a substrate surface, and/or to minimize the likelihood of damaging the substrate surfaces, the contact surfaces 124c, 124d may include a non-scratch surface, such as a cloth material. Alternatively, the contact surfaces 124c, 124d may include rollers (not shown) to guide the tool 102 along the substrate surfaces.

In the illustrated embodiment, the body 118 has an open or hollow construction, and the closely spaced edges 128 define a slot 131, whereby a user can see through the body 118 looking downwardly past the handle 120 and through the slot 131 to view the attachment article 4 in the application path 130 during the application process. In other embodiments, the tool 102 body may be formed with a solid body, or a hollow body with a continuous, or solid, outer surface.

The tool 102 includes a positioner 132 located along the application path 130. The positioner 132 is arranged to align the attachment article 4 with the application path 130 and the force applier 134 during the application process, such that the attachment article 4 will be properly positioned when it is applied to the window frame 8 and window 10.

In the illustrated embodiment, the positioner 132 is a notch or cut-out formed into the bottom edge of the body 118 first end wall portion 118a. That is, the positioner 132 is formed as a unitary portion of at least the body 118 first end wall portion 118a. The profile of the positioner 132 is defined by an arcuate center region 132a and a pair of abutments 132b,c arranged at each end of the center region 132a. In the illustrated embodiment, the profile of the positioner 132 is generally configured to match the profile of the attachment article 4. As such, the distance between the abutments 132b,c generally corresponds to the width of the attachment article 4. A similar positioner 132 may also be provided as part of the body second end wall portion 118b.

The tool 102 further includes an optional force applier 134 located along the application path 130. The force applier 134 is configured to apply a force to the attachment article 4 generally in the direction of the substrate to which the attachment article 4 is being applied, such as a window frame 8 or window film 12.

In the illustrated embodiment, the force applier 134 is a plate-like member slidably connected with the first end wall portion 118a of the body 118 with a retaining member 136 that may be loosened to allow the force applier 134 to be moved relative to the body 118, or tightened to retain the force applier 134 in a selected fixed position. The retaining member 136 may be, for example, a threaded retaining member, such as a screw. Connected in this manner, the force applier 134 may be repeatably moved between a retracted position, wherein the force applier 134 is positioned away from the application path 130, such that the tool 102 may be moved without applying a force to the attachment article 4, and an actuated position wherein the force applier 134 is positioned along the application path 130, such that the force applier 134 contacts the attachment article 4 as the tool 102 is moved along the window 10 and window frame 8 during the application process, and thereby applies a force to the attachment article 4 that causes the adhesive surfaces 4a′, 4c′ of the attachment article 4 to bond with the respective surfaces of the window 10 and window frame 8. A pair of raised abutment rails 138 are arranged on each side of the force applier 134 to maintain the force applier 134 in alignment with the positioner 132.

Referring now to FIG. 3, wherein functionally similar features to those in FIG. 1 are referred to with like reference numerals incremented by 100, there is shown an applicator tool 202 similar to the applicator tool 102 shown in FIG. 1 except the positioner 232 is provided as a separate member connected with the end wall portion 218a of the tool body 218, rather than being formed integrally with the end wall portion 218a, and the rails 138 of the tool shown in FIG. 1 have been removed from each side of the force applier 234.

The positioner 232 may be permanently affixed to the body 218 of the tool 202, or the positioner 232 may be movably connected with the body 218 of the tool 202 via the retaining member 236. If movably connected, the location of the positioner 232 may be adjusted to suit the needs of the user. In addition, because the rails 138 have been removed, the angular orientation of the force applier 234 relative to the positioner 232 and application path 230 may be varied. That is, the force applier 234 may be pivoted so that it is no longer aligned or centered with the application path 230 and positioner 232.

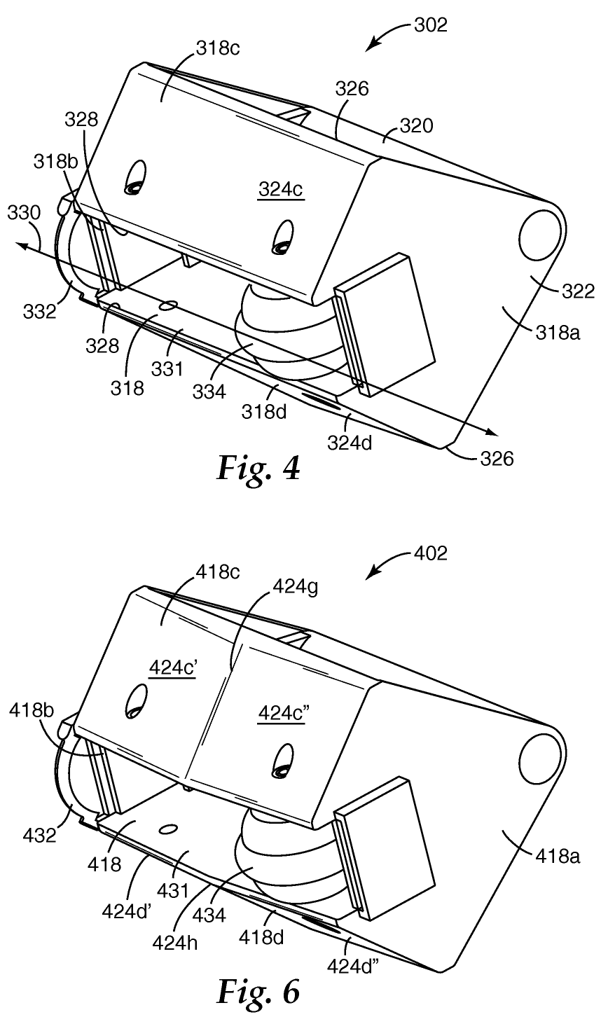

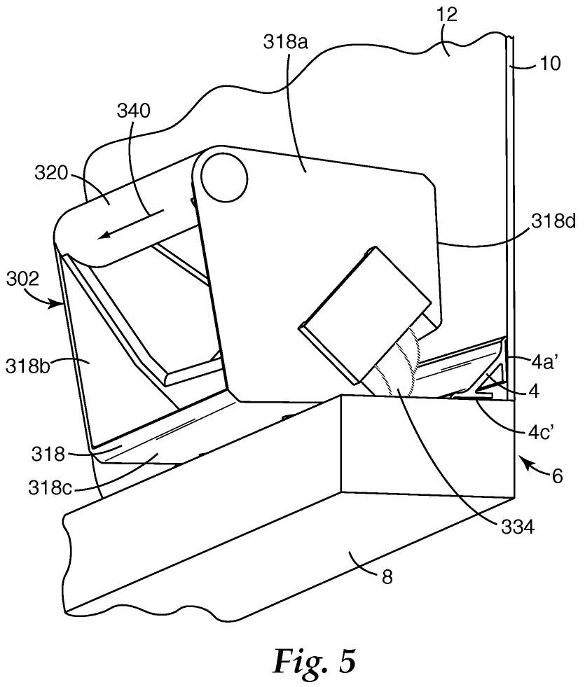

Referring now to FIGS. 4 and 5, wherein functionally similar features to those in FIG. 1 are referred to with like reference numerals incremented by 200, there is shown an applicator tool 302 according to an alternate embodiment of the invention similar to the applicator tool 102 shown in FIG. 1 except the supports 322 are flared out and connect with the widely spaced edges 326 of the contact surfaces 324c, 324d, and the force applier 334 is a disc-like member rotatably connected with the body 318.

The tool 302 generally includes an applicator body 318, a handle 320 connected with the supports 322, a positioner 332 connected with the body 318, and a force applier 334 rotatably connected with the body 318. The handle 320 and positioner 332 may also be formed integrally with the body 318.

The applicator body 318 includes first and second spaced end wall portions 318a, 318b, and first and second angled side wall guide portions 318c, 318d that extend from the first end wall portion 318a to the second end wall portion 318b. The angled side wall guide portions 318c, 318d include contact surfaces 324c, 324d, respectively, for guiding the tool 302 along a substrate surface, such as the surface of a window film 12 applied to a pane of window glass 10, or the surface of a window frame 8, or along two such substrate surfaces simultaneously.

The contact surfaces 324c, 324d, which are configured in a manner similar to contact surfaces 124c, 124d described previously in reference to FIG. 1, taper inwardly in the direction away from the handle 320, thereby defining a pair of widely spaced edges 326 proximate the handle 320, and a pair of closely spaced edges 328 opposite the widely spaced edges 326 that define an application path 330 (FIG. 4), and a slot 331 that extends generally between the closely spaced edges 328 from the first end wall portion 318a to the second end wall portion 318b.

The force applier 334 is a wheel-like member arranged along the application path 330 within the slot 331 between the first 318a and second 318b end wall portions. In the illustrated embodiment, the tool 302 includes one wheel-like force application member 334 rotatably connected with the body 318 within the slot 331 adjacent the first end wall portion 318a of the body 318. The wheel-like force applier 334, however, may be arranged at any position within the slot 331, or it may be arranged adjacent either the first 318a or second 318b end wall portions along the application path 330 outside the slot 331. In addition, more than one wheel-like force applier 334 may be provided, and/or the tool 302 may further include a force applier connected with the end wall portions 318a, 318b similar to the force applier 134 shown in FIG. 1.

Referring to FIG. 5, there is shown the applicator tool 302 being used to apply an attachment article 4 to the respective surfaces of a window frame 8, and a window film 12 applied to a pane of window glass 10. This is accomplished by first providing the elongated adhesive attachment article 4, and loosely arranging it in the corner of the window assembly 6 where it is to be applied.

Next, the tool 302 for applying the attachment article 4 to the window film 12 and the window frame 8, is provided. The tool 302 generally includes a handle portion 320 that is manually grasped by a user, a body portion 318 connected with the handle portion 320, the body portion 318 including end portions 318a,b and first and second angled side portions 318c,d extending between the end portions 318a,b, wherein the angled side portions 318c,d include edges 328 opposite the handle portion 320 defining an application path 330, a positioner 332 (FIG. 4) arranged along the application path 330 to locate the attachment article 4 at the desired location along respective surfaces of the window film 12 and window frame 8, and a force applier 334 arranged along the application path 330 to apply a force to the attachment article 4 in the direction of the window film 12 and window frame 8.

The user then positions the tool 302 with the first and second angled side portions 318c,d abutting the window film 12 and window frame 8, and moves the tool 302 along the window film 12 and window frame 8 with the attachment article 4 positioned in the application path 330 by sliding the tool in the direction of arrow 340 along the window frame 8 and window film 12 such that the angled side portions 318c,d remain in contact the respective surfaces of the window frame 8 and window film 12. As the user slides the tool 302 along the window film 12, the positioner 332 aligns the attachment article 4 with the application path 330 and force applier 334, and locates the attachment article 4 at the desired location along the window film 12 and window frame 8.

As the user slides the tool 302 along the window assembly 6, the force applier 334 forces the attachment article 4 against the window film 12 and window frame 8, thereby adhesively bonding the first portion adhesive surface 4a′ of the attachment article 4 to the window film 12, and adhesively bonding the second portion adhesive surface 4c′ of the attachment article 4 to the window frame 8.

Referring now to FIG. 6, wherein functionally similar features to those in FIG. 4 are referred to with like reference numerals incremented by 100, there is shown an applicator tool 402 according to an alternate embodiment of the invention similar to the applicator tool 302 shown in FIG. 4 except each angled side wall guide portion 418c, 418d includes a pair of sloped contact surfaces 424c′, 424c″ and 424d′, 424d″ arranged at an angle. That is, the angled side wall guide portions 418c, 418d are not planar as in the embodiment of FIG. 4, but include a raised central region 424g,h intermediate the contact surfaces 424c′, 424c″ and 424d′, 424d″, respectively, and each contact surface 424c′, 424c″ and 424d′, 424d′ slopes downwardly away from the raised central region 424g,h toward the first and second end wall portion 418a, 418b, respectively. A force applier 434 arranged in the slot 431 adjacent the first end wall portion 418a is rotatably connected with the body 418, and a positioner 432 is connected with the body 418 adjacent the second end wall portion 418b. As explained below, the sloped contact surfaces 424c′, 424c″ and 424d′, 424d″ allow the positioner 432 and force applier 434 to be used independently in a two-step process of applying an attachment article 4 to the respective surfaces of a window film 12 and window frame 8.

The two-step process involves first loosely arranging the attachment article 4 by hand along the window film 12 and window frame 8 to which it will be applied. The tool 402 is then positioned with the sloped contact surfaces 424c′, 424d′ contacting the respective surfaces of the window film 12 and window frame 8 with the attachment article 4 arranged in the positioner 432. Due to the angled nature of the sloped contact surfaces 424c′, 424d′, the attachment article 4 can be arranged adjacent the positioner 432 while the force applier 434 is angled upwardly away from the attachment article 4, and is, therefore, inoperative.

Next, the tool 402 is moved along the window film 12 and window frame 8 in a first pass, thereby to accurately position the attachment article 4 at the desired location along the window film 12 and window frame 8 in a first step. Once the first pass is completed, the tool 402 is rotated 180 degrees so the locations of the positioner 432 and the force applier 434 are reversed.

The tool 402 is then positioned with the sloped contact surface 424c″, 424c″ contacting the respective surfaces of the window film 12 and window frame 8, and with the force applier 434 contacting the attachment article 4. Due to the angled nature of the sloped contact surfaces 424c″, 424d″, the attachment article 4 can be contacted by the force applier 434 while the positioner 432 is angled upwardly away from the attachment article 4, and is, therefore, inoperative. The tool 402 is then moved in a second pass along the attachment article 4 to press the first and second adhesive surface 4a′, 4c′ of the attachment article 4 against the window film 12 and window frame 8 along the entire length of the attachment article 4 in a second step, thereby to securely bond the attachment article 4 to the respective surfaces of the window film 12 and window frame 8.

This two-step process may be accomplished using a single tool, such as the applicator tool 402 shown in FIG. 6, or using two separate tools; one that first accurately positions the attachment article 4, and a second that presses the attachment article 4 against the respective surfaces of the window film 12 and window frame 8. Alternatively, the attachment article 4 may be hand pressed against the window film 12 and window frame 8 (i.e. without the aid of a tool) in the second step.

The tool according to the various embodiments of the invention may be constructed using a wide variety of materials including synthetic plastic materials, such as ABS, PMMA, and polycarbonate plastics, metals and/or wood.

Persons of ordinary skill in the art may appreciate that various changes and modifications may be made to the invention described above without deviating from the inventive concept. For example, it will be recognized that the positioner and force applier may be combined and provided as either a separate member attached to the body of the tool, or they may be combined and formed integrally with the body of the tool. Thus, the scope of the present invention should not be limited to the structures described in this application, but only by the structures described by the language of the claims and the equivalents of those structures.

What is claimed is:

1. A tool for applying an elongate adhesive attachment article to a substrate, the tool comprising a body including a manual grasping portion, a contact surface for guiding the tool along the substrate, and a positioner configured to align the attachment article on the substrate.

2. A tool as defined in claim 1, further comprising a force applier configured to urge the attachment article toward the substrate.

3. A tool as defined in claim 2, wherein the body comprises a pair of guide portions each having a contact surface.

4. A tool as defined in claim 3, wherein the substrate includes a pair of surfaces arranged at an angle, and the guide portions each include generally planar contact surfaces arranged at an angle configured to match the angle between the substrate surfaces.

5. A tool as defined in claim 4, wherein the contact surfaces include first and second ends, and further include a first top pair of spaced parallel edges adjacent the manual grasping portion, and a second bottom pair of spaced parallel edges opposite the first top pair of parallel edges, and further wherein the distance between the first pair of spaced parallel edges is greater than the distance between the second pair of spaced parallel edges.

6. A tool as defined in claim 5, wherein the second pair of spaced parallel edges define a slot.

7. A tool as defined in claim 6, wherein the tool comprises first and second end portions, and further wherein the force applier is arranged adjacent at least one of the contact surface first and second ends.

8. A tool as defined in claim 7, wherein the force applier is movably connected with at least one of the first and second end portions.

9. A tool as defined in claim 7, wherein the force applier is arranged in the slot between the first and second end portions.

10. A tool as defined in claim 9, wherein the force applier is a disc-like member rotatably connected with the body.

11. A tool as defined in claim 7, wherein the positioner is arranged adjacent at least one of the first and second ends portions.

12. A tool as defined in claim 7, wherein the positioner is a unitary portion of at least one of the first and second end portions.

13. A tool as defined in claim 2, wherein the positioner is formed as a unitary portion of the force applier.

14. A tool for applying an elongated adhesive attachment article to a window film arranged on a pane of window glass, and to a window frame, the tool comprising
a body including at least one end portion, first and second angled side portions extending from the end portion, wherein the angled side portions include a pair of proximal edges defining an application path, and a manual grasping region arranged to allow a user to grasp the tool; and
a positioner configured to align the attachment article with the application path.

15. A tool as defined in claim 14, further comprising a force applier arranged along the application path for applying a force to the attachment article, thereby to secure the attachment article to the window film and window frame.

16. A tool as defined in claim 14, wherein the manual grasping region comprises a handle connected with the body opposite the application path.

17. A method of securing a window film to a window frame, comprising the steps of:
providing an elongate adhesive attachment article;
providing a tool for at least positioning the attachment article on the window film and the window frame, wherein the tool comprises a manual grasping portion, a body portion connected with the manual grasping portion, the body portion including an end portion and first and second angled side portions extending from the end portion, wherein the angled side portions include edges opposite the manual grasping portion defining an application path, and a positioner arranged along the application path to locate the attachment article at the desired location along the window film and window frame;
locating the tool with the first and second angled side portions abutting the window film and window frame; and
moving the tool along the window film and window frame with the attachment article positioned in the application path, whereby the positioner locates the attachment article at the desired location along the window film and window frame.

18. A method as defined in claim 17, wherein the tool further comprises a force applier arranged along the application path to apply a force to the attachment article, and the method further comprises the step of pressing the attachment article against the window film and window frame with the force applier, thereby adhesively bonding at least a portion of the attachment article to the window film and the window frame.

19. A method as defined in claim 18, wherein the attachment article is applied to the substrate by first moving the tool along the window film and window frame to position the attachment article at the desired location along the window film and window frame in a first pass of the tool, and then contacting the positioned attachment article with the force applier and moving the tool along the attachment article to press the attachment article against the window film and window frame in a second pass of the tool.

20. A method as defined in claim 18, wherein the step of positioning the attachment article along the window film and window frame, and the step of pressing the attachment article against the window film and window frame are performed using a single tool.
